(19) United States
(12) Patent Application Publication
(10) Pub. No.: US 2006/0056772 A1
(43) Pub. Date: Mar. 16, 2006

(54) Spectral broadband and a high efficiency light source

(76) Inventor: Manfred Keller, Riegel (DE)

Correspondence Address: Elliott N. Kramsky, Suite 400, 5850 Canoga Avenue, Woodland Hills, CA, 91367, US

(21) Appl. No.: 10/529,571

(22) PCT Filed: Jul. 30, 2003
(86) PCT No.: PCT/EP03/08441

§ 371 Date: Mar. 29, 2005

(30) Foreign Application Priority Data
Sep. 30, 2002 (DE) 102 45 526.0

(51) Int. Cl. G02B 6/36

(52) U.S. Cl. 385/89

(57) ABSTRACT

A spectrally broadband light source of high optical power for fiber optic applications. A number of LEDs are arranged as a monolithic array of adjacent surface-emitting, bright, on a wafer or chip. A microoptics array is arranged upstream of the monolithic LED linear array on the emission side for focusing the light beams emanating from the LEDs. Collecting optics in particular a spherical lens, is provided for optimizing the optical power to be launched into a fiber.

### BACKGROUND

1. Field of the Invention

The invention relates to a spectrally broadband light source. More particularly it pertains to a high optical power light source for use in fiber optic applications such as fiber optic interferometers and fiber optic gyroscopes (FOGs).

2. Description of the Prior Art

Superluminescent diodes have been used as light sources in fiber optic sensors (FOGs, in particular) to insure the two central requirements of (1) spectral broadbandedness and (2) optical power adequate for launching into the fiber. Such light sources are special components that are relatively expensive due to their low numbers. Commercially available, inexpensive alternatives include light-emitting diodes (LEDs) and laser diodes (Lds). LEDs do not fulfill the optical power criterion while LDs do not possess the required spectral properties.

### SUMMARY AND OBJECTS OF THE INVENTION

It is therefore an object of the present invention to provide a spectrally broadband light source of high optical power for fiber optic applications that can be produced by means of an economic automatic mass production process.

The present invention addresses the preceding and other objects by providing a spectrally broadband light source of high optical power for fiber optic applications. Such light source is characterized by a monolithic linear array, arranged on a substrate, in particular a wafer or chip, of adjacent surface-emitting LEDs and a microoptics array arranged upstream of the monolithic LED linear array on the emission side at a prescribed spacing, having optical functions individually assigned to the LED elements in such a way that, for the purpose of optimizing the optical power that can be launched into an optical fiber, the emission of the individual LEDs is focused onto an optical unit arranged upstream of the launch point of the fiber.

The optics unit is preferably designed as a spherical lens arranged at an end of the fiber into which light is radiated.

The foregoing and other features of the invention will become further apparent from the detailed description that follows. Such description is accompanied by a drawing figure. Numerals of the drawing figure, corresponding to those of the written description, point to the features of the invention with like numerals referring to like features throughout both the written description and the drawing.

### BRIEF DESCRIPTION OF THE DRAWING

FIG. 1 is a diagram of the layout of a spectrally broadband light source in accordance with the invention.

### DETAILED DESCRIPTION OF THE PREFERRED EMBODIMENT

The invention consists in the combination of a number of available techniques and elements, including high power LEDs, precise microoptics for beam focusing of the outputs of the individual LEDs, and optics for optimally launching the focused optical power into an optical fiber.

The actual light source is an array, preferably a lens array, in combination with high power, surface-emitting LEDs. The criterion of spectral broadbandedness is met with the latter. Such LEDs can be completely tested on the common wafer. The array consists of LEDs, adjacent, at a small spacing, on the wafer. The number of LEDs employed is determined by the following optical units for beam deflection and focusing as well as the optical power required.

Special microoptics is mounted on the monolithic LED array that consists of an array of individual optical functions for focusing the more or less three-dimensional emissions of the individual LEDs on the chip into a parallel emission. The high optical power criterion is met by this summing of optical powers of the individual LEDs. The use of current methods in the field of microoptics yields complex optical functionality in conjunction with very good adaptation to the LED array. The focusing is very precise in adaptation to the individual LEDs of the array and is, if appropriate, optimized for each LED of the array with regard to direction of emission. Such requirements can be achieved very effectively with microoptics, specifically in a monolithic fashion in a single module. A further optics unit, for example a spherical lens mounted at the end face of the fiber is used for beam focusing and for optimizing the launch into the fiber.

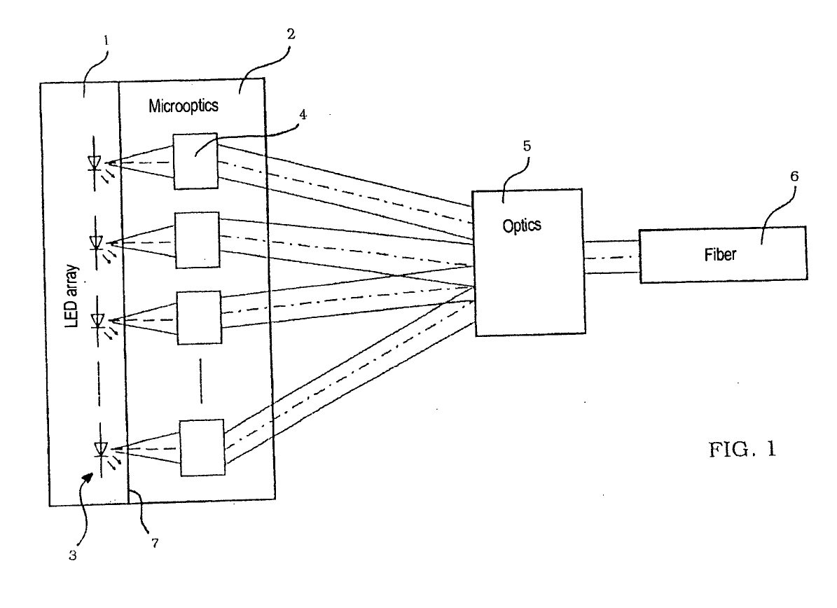

Turning to the drawing, FIG. 1 is a diagram of the layout of a spectrally broadband light source in accordance with the invention. The light source is constructed on a substrate 1, in particular a suitable wafer or chip substrate. A linear array of preferably-equally-spaced high power and surface-emitting LEDs 3 that can all be completely tested directly on the wafer with the aid of known test methods is arranged along a reference line or edge 7. A lens array 4, each of whose individual elements is respectively aligned with one of the LEDS 3 is located a short spacing in the direction of the emission of the LEDs 3. The optical elements of the lens array 4 are arranged and aligned so that the light beams of the individual LED elements 3 are focused onto collecting optics 5 (e.g. a spherical lens) arranged upstream of or on an optical fiber 6.

The following substantial advantages are achieved by the invention:
1. Essential processing and testing steps may be carried out as batch processing. This leads to substantially lower production costs, in particular in the case of chip production and in comparison with the costs for production of a single superluminescent diode having like properties.

2. The production of a chip with the LED linear array and the lens array can be performed by known mass production processes.

3. The chip can be adapted relatively easily to the current state of the art, easily utilizing growth potential that is accomplished in theory by the majority of chip manufacturers.

Apart from fiber optic sensors, the invention is also suitable for specific applications in metrology, in particular, telecommunications, and wherever spectral broadbandedness is required, (e.g. measurement/calibration of WDM or DWDM systems).

While this invention has been described with reference to its presently-preferred embodiment, it is not limited thereto. Rather, the invention is limited only insofar as it is defined by the following set of patent claims and includes within its scope all equivalents thereof.

1. A spectrally broadband light source of high optical power for fiber optic applications, having a linear array, arranged on a substrate, in particular a wafer or chip, of adjacent surface-emitting LEDs and a microoptics array, arranged upstream of the LED linear array on the emission side at a prescribed spacing, having optical functions individually assigned to the led elements in such a way that the emission of the individual LEDs is focused onto an optical unit which serves to optimize the light power that can be launched into an optical fiber, and which is arranged upstream of the launch point of the fiber, characterized in that
the linear array forms a monolithic unit, and the individual elements of the microoptics array are arranged or fashioned such that the light beams emitted by the elements and traveling to the optics unit have different angles of inclination with regard to the longitudinal axis of the fiber.

2. A spectrally broadband light source as claimed in claim 1, characterized in that the optical unit is designed as a collecting optics, in particular as a spherical lens, arranged at an end of the fiber into which light is radiated.
